(19) United States
(12) Patent Application Publication
(10) Pub. No.: US 2025/0304834 A1
(43) Pub. Date: Oct. 2, 2025

(54) DECORATIVE FILM

(71) Applicant: 3M INNOVATIVE PROPERTIES COMPANY, St. Paul, MN (US)

(72) Inventors: Hidetoshi Abe, Yamagata (JP); Ken Okura, Yamagata (JP); Michael Jost, Neuss (DE)

(21) Appl. No.: 18/866,624

(22) PCT Filed: Jun. 9, 2023
(86) PCT No.: PCT/IB2023/055980

§ 371 Date: Nov. 18, 2024

(30) Foreign Application Priority Data
Jun. 16, 2022 (JP) 2022-097372

(51) Int. Cl. C09J 7/38

(52) U.S. Cl. CPC C09J 7/385; C09J 2301/302; C09J 2301/414; C09J 2400/166

(57) ABSTRACT

Provided is a decorative film that can be used for interior and exterior uses, such as uses for vehicles or buildings, and that can conceal an underlying layer surface to a high degree even when the decorative film has a color with high chroma. The decorative film of an embodiment includes a transparent film layer, a first acrylic pressure sensitive adhesive layer containing a colorant, and a second acrylic pressure sensitive adhesive layer containing a white colorant in this order.

### TECHNICAL FIELD

The present disclosure relates to a decorative film.

### BACKGROUND ART

Colored decorative films have been widely used for interior and exterior uses such as uses for vehicles including automobiles, trains, and ships, and for buildings. Colored decorative films are used at the time of, for example, production of vehicles or construction of buildings, or repairing of vehicles and buildings. Colored decorative films preferably efficiently conceal, for example, a color or pattern of a surface of an adherend (underlying layer).

Patent Document 1 (JP 2008-308646 A) describes “a colored tacky acrylic adhesive including a carboxyl group-containing (meth)acrylic polymer, a pigment or dye, and an amino group-containing (meth)acrylic polymer containing no aromatic vinyl monomers” and “a marking film having a base film layer and an adhesive layer formed of the colored tacky acrylic adhesive”.

Patent Document 2 (JP 2003-138235 A) describes: “an adhesive composition having concealing property, the adhesive composition containing: (a) 100 parts by weight of a resin component contained in a copolymer having an alkyl (meth)acrylate monomer as a main component, the alkyl (meth)acrylate monomer having an alkyl group that contains from 1 to 12 carbons, (b) from 0.1 to 5 parts by weight of surface-treated aluminum particles, having an average particle size of 5 to 50 μm and an aspect ratio of 50 to 200, and (c) from 5 to 60 parts by weight of titanium oxide”; and “an adhesive sheet obtained by applying and drying the adhesive composition having concealing property on a substrate sheet”.

Patent Document 3 (JP 2003-183602 A) describes “an adhesive sheet for decorative use, which is characterized by including an adhesive agent containing: from 3 to 50 parts by weight of a white pigment relative to 100 parts by weight of a base polymer of the adhesive agent, and from 0.3 to 2 wt % of aluminum metal pieces relative to the amount of the white pigment added, the adhesive agent being laminated on one surface of a colored film having a total light transmittance of 3 to 80%”.

### SUMMARY OF INVENTION

### Technical Problem

Colors of underlying layer surfaces to which colored decorative films are applied are various colors, and colors of decorative films are also various colors. For example, when the color of a decorative film is yellow, magenta, or beige with high chroma, the underlying layer surface may not be sufficiently concealed by the decorative film. In particular, when the lightness of the underlying layer surface is low, or when the underlying layer surface has various hue, lightness, or chroma or a combination of at least two of these, insufficient concealing property of the decorative film may be remarkably, visually recognized.

The present disclosure provides a decorative film that can be used for interior and exterior uses such as uses for vehicles or buildings and that can conceal an underlying layer surface to a high degree even when the decorative film has a color with high chroma.

### Solution to Problem

The inventors of the present invention found that a decorative film having both high chroma and concealing property can be provided by making a pressure sensitive adhesive layer of the decorative film to have a laminar structure including two layers, which are a first acrylic pressure sensitive adhesive layer containing a colorant and a second acrylic pressure sensitive adhesive layer containing a white colorant.

According to an embodiment, a decorative film including a transparent film layer, a first acrylic pressure sensitive adhesive layer containing a colorant, and a second acrylic pressure sensitive adhesive layer containing a white colorant in this order is provided. In a partial laminate that is a component of the decorative film and that includes the transparent film layer and the first acrylic pressure sensitive adhesive layer but does not include the second acrylic pressure sensitive adhesive layer, when a color difference ΔE* is measured from a side of the transparent film layer with background colors being white and black, the color difference ΔE* is 13 or greater between a part of the white background color and a part of the black background color, and in the decorative film, when a color difference ΔE* is measured from the side of the transparent film layer with background colors being white and black, the color difference ΔE* is 11 or less between a part of the white background color and a part of the black background color.

### Advantageous Effects of Invention

According to the present disclosure, a decorative film that can be used for interior and exterior uses such as uses for vehicles or buildings and that can conceal an underlying layer surface to a high degree even when the decorative film has a color with high chroma can be provided.

Note that the above description is not construed as disclosure of all of embodiments of the present invention and advantages related to the present invention.

### BRIEF DESCRIPTION OF DRAWINGS

FIG. 1 is a schematic cross-sectional view of a decorative film of one embodiment.

### DESCRIPTION OF EMBODIMENTS

Hereinafter, the present invention will be described in more detail with reference to the drawings for the purpose of illustrating representative embodiments of the present invention, but the present invention is not limited to these embodiments.

In the present disclosure, the term “(meth)acrylic” refers to acrylic or methacrylic, and the term “(meth)acrylate” refers to acrylate or methacrylate.

In the present disclosure, the term “film” encompasses articles referred to as “sheets”.

In the present disclosure, “pressure-sensitive adhesive(ness)” refers to the characteristic of a material or composition that the material or composition adheres to various surfaces by application of little pressure for a short time in the temperature range of usage, such as from 0° C. to 50° C., and does not exhibit a phase change (from liquid to solid). In the present disclosure, “adhesive(ness)” is used interchangeably with “pressure-sensitive adhesive(ness)”.

In the present disclosure, “disposed on” refers to not only the case of being directly disposed on, but also the case of being indirectly disposed on, that is, disposed via another material or layer on.

In the present disclosure, “titanium oxide” is used interchangeably with “titanium dioxide (TiO₂)”.

The decorative film of an embodiment includes a transparent film layer, a first acrylic pressure sensitive adhesive layer containing a colorant, and a second acrylic pressure sensitive adhesive layer containing a white colorant in this order. In a partial laminate that is a component of the decorative film and that includes the transparent film layer and the first acrylic pressure sensitive adhesive layer but does not include the second acrylic pressure sensitive adhesive layer, when a color difference ΔE* is measured from a side of the transparent film layer with the background color being white and black, the color difference ΔE* is 13 or greater between a part of the white background color and a part of the black background color. In the decorative film, when a color difference ΔE* is measured from a side of the transparent film layer with the background color being white and black, the color difference ΔE is 11 or less between a part of the white background color and a part of the black background color.

In an embodiment, the decorative film includes a transparent film layer, a first acrylic pressure sensitive adhesive layer containing a colorant, and a second acrylic pressure sensitive adhesive layer containing a white colorant in this order. “Including a transparent film layer, a first acrylic pressure sensitive adhesive layer containing a colorant, and a second acrylic pressure sensitive adhesive layer containing a white colorant” means that the decorative film does not include any layers other than the transparent film layer, the first acrylic pressure sensitive adhesive layer, the second acrylic pressure sensitive adhesive layer, and a liner that is removed at the time of use. The decorative film of this embodiment has a simple layer structure and thus can more advantageously accommodate regulations relating to flame retardance in each country.

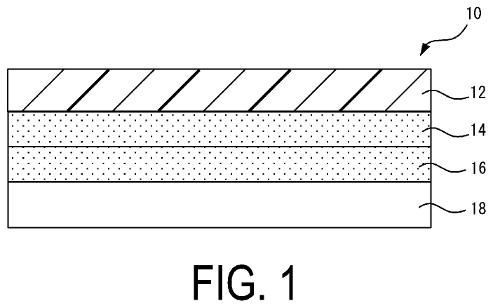

FIG. 1 illustrates a schematic cross-sectional view of a decorative film of an embodiment. The decorative film 10 includes a transparent film layer 12, a first acrylic pressure sensitive adhesive layer 14, and a second acrylic pressure sensitive adhesive layer 16 in this order. The decorative film 10 of FIG. 1 further includes a liner 18 as an optional component. The liner 18 is removed before adhesion of the decorative film 10 to an adherend.

As the transparent film layer, various resin films can be used without particular limitation. Examples of the resin film include acrylic resin films, polyvinylidene fluoride (PVdF) films, polyurethane films, polyester films such as polyethylene terephthalate (PET) films, and polyvinyl chloride (PVC) films. The transparent film layer preferably has flexibility. The transparent film layer may be a single layer or may be a laminate of two or more layers containing different materials.

The transparent film layer may contain additives such as UV absorbing agents, light stabilizers, antioxidants, heat stabilizers, and fillers as optional components.

A thickness of the transparent film layer may be any thickness and, for example, the thickness can be approximately 10 μm or greater, approximately 12 μm or greater, or approximately 15 μm or greater, and approximately 200 μm or less, approximately 150 μm or less, or approximately 100 μm or less. From the perspectives of elongation and nonflammability of the decorative film, the thickness of the transparent film layer is preferably approximately 80 μm or less, and more preferably approximately 50 μm or less.

The transparent film layer is preferably colorless and transparent or preferably has transparency to a degree that presence of a color of the first acrylic pressure sensitive adhesive layer can be visually recognized through the transparent film layer. In an embodiment, the total light transmittance of the transparent film layer in a wavelength range of 380 to 780 nm is approximately 80% or greater, approximately 85% or greater, or approximately 90% or greater, and 100% or less. The total light transmittance in the present disclosure is measured in accordance with JIS A 5759:2008. In the decorative film, the transparent film layer having the total light transmittance described above can facilitate visual recognition of the original hue, lightness, and chroma of the combination of the first acrylic pressure sensitive adhesive layer and the second acrylic pressure sensitive adhesive layer with substantially no changes. Thus, the workload resulting from color matching when the first acrylic pressure sensitive adhesive layer and the second acrylic pressure sensitive adhesive layer are formed can be reduced.

The surface of the transparent film layer may have undergone a surface treatment, such as corona treatment or plasma treatment, and a primer layer may be formed on the surface of the transparent film layer. Adhesive properties between the transparent film layer and the first acrylic pressure sensitive adhesive layer can be even more enhanced by the surface treatment or the primer layer.

A surface of the transparent film layer, the surface being on a side opposite to the first acrylic pressure sensitive adhesive layer, may be subjected to emboss finishing or may be provided with a surface-protecting layer such as a hard coat layer.

The first acrylic pressure sensitive adhesive layer includes a colorant, and mainly contributes to hue, brightness, and chroma of the decorative film. The first acrylic pressure sensitive adhesive layer can be formed by typically using an adhesive polymer and a first colored adhesive composition containing a colorant. The adhesive polymer may be a (meth)acrylic polymer. The first acrylic pressure sensitive adhesive layer may be crosslinked with a crosslinking agent such as a bisamide crosslinking agent, an aziridine crosslinking agent, a carbodiimide crosslinking agent, an epoxy crosslinking agent, or an isocyanate crosslinking agent.

Examples of the colorant include pigments and dyes. A pigment or dye can each be used alone, or two or more of them can each be used in combination. The form of the pigment and dye is not particularly limited and may have undergone dispersion treatment.

Examples of the pigment include inorganic pigments, such as titanium oxide, zinc carbonate, zinc oxide, zinc sulfide, talc, kaolin, calcium carbonate, carbon black, chrome yellow, yellow iron oxide, colcothar, red iron oxide, barium sulfate, alumina, zirconia, iron oxide-based pigments, iron hydroxide-based pigments, chromium oxide-based pigments, spinel-type calcined pigments, chromic acid-based pigments, chrome vermilion-based pigments, iron blue-based pigments, aluminum powder-based pigments, bronze powder-based pigments, and calcium phosphate; and organic pigments, such as phthalocyanine-based pigments such as phthalocyanine blue and phthalocyanine green, azo-based pigments, condensed azo-based pigments, azo lake-based pigments, anthraquinone-based pigments, indigo-based pigments, thioindigo-based pigments, isoindolinone-based pigments, azomethine azo-based pigments, aniline black-based pigments, triphenylmethane-based pigments, perinone-based pigments, perylene-based pigments, quinophthalone-based pigments, dioxazine-based pigments, and quinacridone-based pigments, such as quinacridone red.

Examples of the dye include azo-based dyes, anthraquinone-based dyes, quinophthalone-based dyes, styryl-based dyes, diphenylmethane-based dyes, triphenylmethane-based dyes, oxazine-based dyes, triazine-based dyes, xanthane-based dyes, azomethine-based dyes, acridine-based dyes, and diazine-based dyes.

The content of the colorant may be varied based on the hue, lightness, and chroma desired for the decorative film and, for example, can be approximately 0.1 mass % or greater, approximately 0.5 mass % or greater, or approximately 1 mass % or greater, and approximately 50 mass % or less, approximately 45 mass % or less, or approximately 40 mass % or less, based on the mass of the first acrylic pressure sensitive adhesive layer.

In an embodiment, the glass transition temperature (Tg) of the adhesive polymer of the first acrylic pressure sensitive adhesive layer is approximately −40° C. or lower. As described above, the first acrylic pressure sensitive adhesive layer is a layer having a function of adjusting the hue, lightness, and chroma of the decorative film. By setting the glass transition temperature of the adhesive polymer to approximately −40° C. or lower, the first acrylic pressure sensitive adhesive layer can adhere the transparent film layer and the second acrylic pressure sensitive adhesive layer more suitably. Thus, the first acrylic pressure sensitive adhesive layer of this embodiment can also function as a bonding layer that firmly bonds the transparent film layer and the second acrylic pressure sensitive adhesive layer and that further enhances unification of the decorative film.

In a case where an adhesive polymer is a (meth)acrylic polymer, a calculated glass transition temperature can be determined according to the following Fox equation (Fox, T. G., Bull. Am. Phys. Soc., 1 (1956), p. 123), assuming that each of the polymers is copolymerized with n types of monomers.

$$\frac{1}{Tg + 273.15} = {\sum }_{i = 1}^{n} ( \frac{{X}_{i}}{{Tg}_{i} + 273.15} ) . \qquad [ Math . 1 ]$$

In the equation, Tgᵢ represents the glass transition temperature (° C.) of a homopolymer of a component i, Xᵢ represents the mass fraction of the monomer of the component i added during polymerization, and i is a natural number of 1 to n, and

$${\sum }_{i = 1}^{n} {X}_{i} = 1. \qquad [ Math . 2 ]$$

In an embodiment, the first acrylic pressure sensitive adhesive layer contains a carboxy group-containing (meth)acrylic polymer and an amino group-containing (meth)acrylic polymer. The carboxy group-containing (meth)acrylic polymer and the amino group-containing (meth)acrylic polymer have capability of stably dispersing a large amount of colorant in the first acrylic pressure sensitive adhesive layer. Thus, even when the first acrylic pressure sensitive adhesive layer is made relatively thin, various hue, lightness, and chroma can be imparted to the first acrylic pressure sensitive adhesive layer. Capability of making the first acrylic pressure sensitive adhesive layer thin is advantageous from the perspective of nonflammability of the decorative film. Furthermore, the carboxy group-containing (meth)acrylic polymer and the amino group-containing (meth)acrylic polymer interact with each other and can suppress reduction in cohesive force of the first acrylic pressure sensitive adhesive layer due to dispersion of the colorant and can maintain the adhesive properties. Thus, lamination of the first acrylic pressure sensitive adhesive layer and the second acrylic pressure sensitive adhesive layer, which will be described below as a production method of the decorative film, can be further facilitated. The carboxy group-containing (meth)acrylic polymer and/or the amino group-containing (meth)acrylic polymer may be crosslinked with the above-described crosslinking agent.

The carboxy group-containing (meth)acrylic polymer can be obtained by copolymerizing a polymerizable composition containing a (meth)acrylic monomer and a carboxy group-containing monomer and, as necessary, a monomer having another monoethylenic unsaturated group. In the present disclosure, a (meth)acrylic monomer, a carboxy group-containing monomer, an amino group-containing monomer, and a monomer having another monoethylenic unsaturated group are collectively referred to as polymerizable components. The (meth)acrylic monomer, the carboxy group-containing monomer, and the monomer having another monoethylenic unsaturated group may be used alone or may be used in combination of two or more types.

The (meth)acrylic monomer typically includes an alkyl (meth)acrylate. The number of carbon atoms of the alkyl group of the alkyl (meth)acrylate may be from 1 to 12. Examples of the alkyl (meth)acrylate include linear or branched alkyl (meth)acrylate, such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylate, such as cyclohexyl (meth)acrylate, 4-t-butylcyclohexyl (meth)acrylate, and isobornyl (meth)acrylate. The alkyl (meth)acrylate preferably includes methyl (meth)acrylate, n-butyl (meth)acrylate, 2-ethylhexyl acrylate, or a combination of these.

The alkyl (meth)acrylate constitutes the main component of the carboxy group-containing (meth)acrylic polymer. In an embodiment, the carboxy group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

The (meth)acrylic monomer may include aromatic (meth)acrylate such as phenyl (meth)acrylate and p-tolyl (meth)acrylate; phenoxy alkyl (meth)acrylate such as phenoxy ethyl (meth)acrylate; alkoxy alkyl (meth)acrylate such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

Examples of the carboxy group-containing monomer include (meth)acrylic acid, phthalic acid monohydroxyethyl (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid. As the carboxy group-containing monomer, (meth)acrylic acid is preferred. In the present disclosure, a substance that corresponds to the (meth)acrylic monomer and the carboxy group-containing monomer, such as (meth)acrylic acid, is treated as a carboxy group-containing monomer.

In an embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, and approximately 15 mass % or less, approximately 10 mass % or less, or approximately 8 mass % or less, relative to the mass of the polymerizable components, and includes structural units derived from the carboxy group-containing monomer in the mass ratio described above.

Examples of the (meth)acrylic monomer or the monomer having another monoethylenic unsaturated group include amide group-containing monomers, such as (meth)acrylamide, N-vinylpyrrolidone, and N-vinylcaprolactam; hydroxy group-containing monomers, such as 2-hydroxyethyl (meth)acrylate, 2-hydroxypropyl (meth)acrylate, and 4-hydroxybutyl (meth)acrylate; unsaturated nitriles, such as (meth)acrylonitrile; aromatic vinyl monomers, such as styrene, α-methylstyrene, and vinyl toluene; and vinyl esters, such as vinyl acetate.

The copolymerization of the carboxy group-containing (meth)acrylic polymer can be performed by radical polymerization. As the radical polymerization, a known polymerization method can be utilized, such as solution polymerization, suspension polymerization, emulsion polymerization, and bulk polymerization. It is advantageous to use solution polymerization that can easily synthesize a polymer with a high molecular weight. As the polymerization initiator, for example, an organic peroxide such as benzoyl peroxide, lauroyl peroxide, or bis(4-tert-butylcyclohexyl)peroxydicarbonate; or an azo-based polymerization initiator such as 2,2′-azobisisobutyronitrile, 2,2′-azobis(2-methylbutyronitrile), dimethyl-2,2-azobis(2-methylpropionate), 4,4′-azobis(4-cyanovalerianic acid), dimethyl 2,2′-azobis(2-methylpropionate), or azobis(2,4-dimethylvaleronitrile) (AVN) can be used. The polymerization initiator is used typically in an amount of approximately 0.01 parts by mass or greater, or approximately 0.05 parts by mass or greater, and approximately 5 parts by mass or less, or approximately 3 parts by mass or less, relative to 100 parts by mass of the polymerizable components.

The amino group-containing (meth)acrylic polymer increases cohesive force of the first acrylic pressure sensitive adhesive layer through the interaction with the carboxy group-containing (meth)acrylic polymer and can improve adhesive properties of the first acrylic pressure sensitive adhesive layer. The cohesive force improvement also contributes to improvement of adhesive properties between the first acrylic pressure sensitive adhesive layer and the second acrylic pressure sensitive adhesive layer.

The amino group-containing (meth)acrylic polymer can be obtained by copolymerizing a polymerizable composition containing a (meth)acrylic monomer and an amino group-containing monomer and, as necessary, a monomer having another monoethylenic unsaturated group. The (meth)acrylic monomer, the amino group-containing monomer, and the monomer having another monoethylenic unsaturated group may be used alone or may be used in combination of two or more types.

As the (meth)acrylic monomer and the monomer having another monoethylenic unsaturated group, the groups identical to those described for the carboxy group-containing (meth)acrylic polymer can be used.

The alkyl (meth)acrylate constitutes the main component of the amino group-containing (meth)acrylic polymer. In an embodiment, the amino group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

Examples of the amino group-containing monomer include aminoalkyl (meth)acrylate such as aminoethyl (meth)acrylate; monoalkylaminoalkyl (meth)acrylate such as butylaminoethyl (meth)acrylate; dialkylaminoalkyl (meth)acrylates such as N,N-dimethylaminoethyl acrylate (DMAEA) and N,N-dimethylaminoethyl methacrylate (DMAEMA); dialkylaminoalkyl (meth)acrylamides such as N,N-dimethylaminopropyl acrylamide (DMAPAA) and N,N-dimethylaminopropyl methacrylamide; and dialkylaminoalkyl vinyl ethers such as N,N-dimethylaminoethyl vinyl ether and N,N-diethylaminoethyl vinyl ether. As the amino group-containing monomer, dialkylamino alkyl (meth)acrylate such as N,N-dimethylaminoethyl acrylate (DMAEA) or N,N-dimethylaminoethyl methacrylate (DMAEMA) is preferred. In the present disclosure, a substance that corresponds to the (meth)acrylic monomer and the amino group-containing monomer, such as aminoethyl (meth)acrylate, is treated as an amino group-containing monomer.

In an embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 2 mass % or greater, and approximately 20 mass % or less, approximately 15 mass % or less, or approximately 10 mass % or less, relative to the mass of the polymerizable components, and includes structural units derived from the amino group-containing monomer in the mass ratio described above.

The amino group-containing (meth)acrylic polymer is preferably an amino group-containing (meth)acrylic polymer containing no monomer unit derived from aromatic vinyl monomers (hereinafter, in the present disclosure, also referred to as “amino group-containing non-aromatic (meth)acrylic polymer”). The amino group-containing non-aromatic (meth)acrylic polymer has excellent miscibility with the carboxy group-containing (meth)acrylic polymer and thus enables the interaction with the carboxy group-containing (meth)acrylic polymer to be more effective.

The amino group-containing non-aromatic (meth)acrylic polymer contains no structural units derived from aromatic vinyl monomers. Examples of the aromatic vinyl monomer include styrene, α-methylstyrene, vinyltoluene, vinylnaphthalene, vinylanthracene, vinylanthraquinone, (meth)acrylamide of aromatic amine, and (meth)acrylate of hydroxy group-containing aromatic compounds. Examples of the aromatic amine include aniline, benzylamine, naphthylamine, aminoanthracene, aminoanthraquinone, and derivatives of these. Examples of the hydroxy group-containing aromatic compound include hydroxy group-containing compounds corresponding to the aromatic amines described above.

The copolymerization of the amino group-containing (meth)acrylic polymer can be performed by radical polymerization in the same manner as for the copolymerization of the carboxy group-containing (meth)acrylic polymer. The polymerization method, the polymerization initiator and the used amount thereof are the same as those described for the copolymerization of the carboxy group-containing (meth)acrylic polymer.

In the first acrylic pressure sensitive adhesive layer, at least one of the carboxy group-containing (meth)acrylic polymer or the amino group-containing (meth)acrylic polymer functions as an acrylic adhesive polymer. The acrylic adhesive polymer imparts pressure sensitive adhesiveness to the first acrylic pressure sensitive adhesive layer at the operating temperature (e.g., 5° C. to 35° C.).

The glass transition temperature (Tg) of the acrylic adhesive polymer may be approximately −70° C. to approximately −40° C. In an embodiment, the glass transition temperature of the acrylic adhesive polymer is approximately −65° C. or higher, or approximately −60° C. or higher, and approximately −45° C. or lower, or approximately −50° C. or lower. By setting the glass transition temperature of the acrylic adhesive polymer to approximately −70° C. or higher, adhesive strength to the second acrylic pressure sensitive adhesive layer can be imparted to the first acrylic pressure sensitive adhesive layer. By setting the glass transition temperature of the acrylic adhesive polymer to approximately −40° C. or lower, the first acrylic pressure sensitive adhesive layer can adhere the transparent film layer and the second acrylic pressure sensitive adhesive layer more suitably. Thus, the first acrylic pressure sensitive adhesive layer can also function as a bonding layer that firmly bonds the transparent film layer and the second acrylic pressure sensitive adhesive layer and that further enhances unification of the decorative film. The glass transition temperature (Tg) of the acrylic adhesive polymer can be determined as a calculated glass transition temperature by using the Fox equation described above.

In an embodiment, the weight average molecular weight (Mw) of the acrylic adhesive polymer is approximately 150000 or greater, approximately 200000 or greater, or approximately 250000 or greater, and approximately 2000000 or less, approximately 1500000 or less, or approximately 1000000 or less. In the present disclosure, “weight average molecular weight” is a molecular weight in terms of polystyrene standard by the gel permeation chromatography (GPC) method.

The mass ratio of the carboxy group-containing (meth)acrylic polymer to the amino group-containing (meth)acrylic polymer is 100:approximately 0.1 to 50, 100:approximately 1 to 40, or 100:approximately 2 to 30 (in a case where the carboxy group-containing (meth)acrylic polymer functions as the acrylic adhesive polymer), or approximately 0.1 to 50:100, approximately 1 to 40:100, or approximately 2 to 30:100 (in a case where the amino group-containing (meth)acrylic polymer functions as the acrylic adhesive polymer).

In an embodiment, another (meth)acrylic polymer that is different from the (meth)acrylic polymer functioning as an acrylic adhesive polymer may function as an acrylic polymer additive. That is, in a case where the carboxy group-containing (meth)acrylic polymer functions as the acrylic adhesive polymer, the amino group-containing (meth)acrylic polymer may function as the acrylic polymer additive, and in a case where the amino group-containing (meth)acrylic polymer functions as the acrylic adhesive polymer, the carboxy group-containing (meth)acrylic polymer may function as the acrylic polymer additive. Through acid (carboxy group)-base (amino group) interaction with the acrylic adhesive polymer, the acrylic polymer additive can suppress reduction of the cohesive force due to depolymerization of the acrylic adhesive polymer caused by exposure to sunlight or the like, and can maintain the adhesive strength of the first acrylic pressure sensitive adhesive layer to a desired level.

In an embodiment, the carboxy group-containing (meth)acrylic polymer is the acrylic adhesive polymer, and the amino group-containing (meth)acrylic polymer is the acrylic polymer additive.

The glass transition temperature (Tg) of the acrylic polymer additive can be approximately 20° C. to approximately 120° C. In an embodiment, the glass transition temperature of the acrylic polymer additive is approximately 30° C. or higher, or approximately 45° C. or higher, and approximately 100° C. or lower, or approximately 80° C. or lower. By setting the glass transition temperature of the acrylic polymer additive to approximately 20° C. or higher, it is possible to suppress reduction of the cohesive force due to depolymerization of the acrylic adhesive polymer caused by exposure to sunlight or the like, and to maintain the adhesive strength of the first acrylic pressure sensitive adhesive layer to a desired level. By setting the glass transition temperature of the acrylic polymer additive to approximately 120° C. or lower, adhesiveness in an ordinary temperature range can be secured. The glass transition temperature of the acrylic polymer additive can be determined by using the Fox equation similarly to the acrylic adhesive polymer.

In an embodiment, the weight average molecular weight (Mw) of the acrylic polymer additive is approximately 1000 or greater, approximately 5000 or greater, or approximately 10000 or greater, and approximately 200000 or less, approximately 100000 or less, or approximately 80000 or less.

At least one of the carboxy group-containing (meth)acrylic polymer or the amino group-containing (meth)acrylic polymer may function as a dispersant for the colorant. In this embodiment, a premix (also referred to as millbase) may be prepared by mixing the colorant and a (meth)acrylic polymer functioning as a dispersant, and the obtained premix may be mixed with other components of the first colored adhesive composition used to form the first acrylic pressure sensitive adhesive layer. Thus, a large amount of the colorant can be stably dispersed in the first acrylic pressure sensitive adhesive layer. A premix is prepared for each of a plurality of colorants, these premixes are appropriately mixed, thereby color matching can also be facilitated.

The carboxy group-containing (meth)acrylic polymer or the amino group-containing (meth)acrylic polymer that functions as a dispersant may be the same or different from the substance that functions as the acrylic adhesive polymer or the acrylic polymer additive. In the latter case, the first acrylic pressure sensitive adhesive layer contains two or more types of carboxy group-containing (meth)acrylic polymers or amino group-containing (meth)acrylic polymers, that is, contains a carboxy group-containing (meth)acrylic polymer or amino group-containing (meth)acrylic polymer that functions as a dispersant, and a carboxy group-containing (meth)acrylic polymer or amino group-containing (meth)acrylic polymer that functions as an acrylic adhesive polymer or acrylic polymer additive.

The weight average molecular weight (Mw) of the carboxy group-containing (meth)acrylic polymer or amino group-containing (meth)acrylic polymer that functions as the dispersant can be typically approximately 1000 or greater or approximately 10000 or greater, and approximately 1500000 or less or approximately 800000 or less.

The first acrylic pressure sensitive adhesive layer can be formed on the transparent film layer or the liner by using a first colored adhesive composition containing the carboxy group-containing (meth)acrylic polymer, the amino group-containing (meth)acrylic polymer, and the colorant, and, as necessary, a crosslinking agent, a solvent, and/or other additives.

Prior to preparation of the first colored adhesive composition, a premix may be prepared by mixing the colorant, the carboxy group-containing (meth)acrylic polymer or amino group-containing (meth)acrylic polymer that functions as a dispersant. The mixing can be performed by using, for example, a paint shaker, a sand grind mill, a ball mill, an attritor mill, or a three roll mill. At the time of mixing, as necessary, a water-based solvent or an organic solvent may be added. The resulting premix is mixed with an additional component of the first colored adhesive composition, and the first colored adhesive composition can be prepared. When a plurality of the colorants are used, a premix may be prepared for each colorant, and these premixes are appropriately mixed to match color, and then the premix mixture may be mixed with another component of the first colored adhesive composition.

The mass ratio of the total amount of colorant to the amount of the dispersant can be approximately 1 to 100:approximately 5 to 1000, approximately 1 to 100:approximately 10 to 700, or approximately 1 to 100:approximately 10 to 500. The entire amount of the dispersant may be used during preparation of the premix, or a part of the dispersant may be used during preparation of the premix and the rest of the dispersant may be used during preparation of the first colored adhesive composition.

The crosslinking agent is not particularly limited as long as the crosslinking agent can form a crosslink between polymer chains of the carboxy group-containing (meth)acrylic polymer or amino group-containing (meth)acrylic polymer. For example, as the crosslinking agent of the carboxy group-containing (meth)acrylic polymer, an epoxy crosslinking agent, a bisamide crosslinking agent, an aziridine crosslinking agent, a carbodiimide crosslinking agent, or an isocyanate crosslinking agent can be used.

Examples of the epoxy crosslinking agent include N,N,N′,N′-tetraglycidyl-1,3-benzenedi(methanamine) (trade name: TETRAD-X (Mitsubishi Gas Chemical Company Inc., Chiyoda-ku, Tokyo, Japan), E-AX and E-5XM (both from Soken Chemical & Engineering Co., Ltd., Toshima-ku, Tokyo, Japan)); and N,N′-(cyclohexane-1,3-diylbismethylene)bis(diglycidylamine) (trade name: TETRAD-C (Mitsubishi Gas Chemical Company Inc., Chiyoda-ku, Tokyo, Japan), and E-5C (Soken Chemical & Engineering Co., Ltd., Toshima-ku, Tokyo, Japan)).

Examples of the bisamide crosslinking agent include 1,1′-isophthaloyl-bis(2-methylaziridine), 1,4-bis(ethyleneiminocarbonylamino)benzene, 4,4′-bis(ethyleneiminocarbonylamino)diphenylmethane, and 1,8-bis(ethyleneiminocarbonylamino)octane.

Examples of the aziridine crosslinking agent include 2,2-bishydroxymethylbutanol-tris[3-(1-aziridinyl)propionate (trade name: CHEMITITE (trade name) PZ-33 (Nippon Shokubai Co., Ltd. (Osaka-shi, Osaka, Japan)), and Crosslinker CX-100 (DSM Coating Resins B. V. (Zwolle, Netherlands)).

Examples of the carbodiimide crosslinking agent include Carbodilite V-03, V-05, and V-07 (all from Nisshinbo Chemical Inc. (Chuo-ku, Tokyo, Japan)).

Examples of the isocyanate crosslinking agent include Coronate L and Coronate HK (both from Tosoh Corporation (Minato-ku, Tokyo, Japan)).

The crosslinking agent can be used in an amount of approximately 0.01 parts by mass or greater, approximately 0.02 parts by mass or greater, or approximately 0.05 parts by mass or greater, and approximately 0.5 parts by mass or less, approximately 0.4 parts by mass or less, or approximately 0.3 parts by mass or less, per 100 parts by mass of the carboxy group-containing (meth)acrylic polymer or amino group-containing (meth)acrylic polymer that functions as the acrylic adhesive polymer.

Examples of the solvent include methanol, ethanol, hexane, heptane, toluene, acetone, methyl ethyl ketone, methyl isobutyl ketone, ethyl acetate, butyl acetate, and mixed solvents thereof.

Examples of other additives include UV absorbents, antioxidants, thermal stabilizers, fillers, and tackifiers.

The thickness of the first acrylic pressure sensitive adhesive layer may be varied based on the hue, lightness, and chroma desired for the decorative film and, for example, can be approximately 5 μm or greater, approximately 10 μm or greater, or approximately 15 μm or greater, and approximately 100 μm or less, approximately 80 μm or less, or approximately 50 μm or less. From the perspective of nonflammability of the decorative film, the thickness of the first acrylic pressure sensitive adhesive layer is preferably approximately 80 μm or less, and more preferably approximately 50 μm or less.

The second acrylic pressure sensitive adhesive layer contains a white colorant and contributes mainly to concealing property and adhesive properties of the decorative film. Both high chroma and high concealing property can be imparted to the decorative film by making a pressure sensitive adhesive layer of the decorative film to have a laminar structure including two layers, which are a first acrylic pressure sensitive adhesive layer containing a colorant and a second acrylic pressure sensitive adhesive layer containing a white colorant.

The second acrylic pressure sensitive adhesive layer can be formed by typically using an adhesive polymer and a second colored adhesive composition containing a white colorant. The adhesive polymer may be a (meth)acrylic polymer described for the first acrylic pressure sensitive adhesive. The second acrylic pressure sensitive adhesive layer may be crosslinked by a crosslinking agent described for the first acrylic pressure sensitive adhesive layer.

Examples of the white colorant include white pigments such as titanium oxide, zinc carbonate, zinc oxide, calcium carbonate, and barium sulfate. The white colorant may be used as one type or as a combination of two or more types. The form of the white colorant is not particularly limited, and the white colorant may have undergone dispersion treatment.

The white pigment is preferably titanium oxide. Titanium oxide acts as a flame retardant and can also increase flame retardance of the decorative film.

The average particle size of titanium oxide can be approximately 0.1 μm or greater or approximately 0.15 μm or greater and approximately 5 μm or less or approximately 3 μm or less. The average particle size in the present disclosure is a value not for aggregated particles (secondary particles) but for primary particles. The average particle size of titanium oxide is a volume cumulative particle size D₅₀ that can be determined by laser diffraction/scattering particle size distribution measurement.

The content of the white colorant may be varied based on the concealing property and adhesive properties desired for the decorative film and, for example, can be approximately 5 mass % or greater, approximately 10 mass % or greater, or approximately 15 mass % or greater, and approximately 50 mass % or less, approximately 45 mass % or less, or approximately 40 mass % or less, based on the mass of the second acrylic pressure sensitive adhesive layer. The second acrylic pressure sensitive adhesive layer contains from approximately 5 mass % to approximately 50 mass % of titanium oxide, and this can partially or completely conceal an adherend (underlying layer) surface to which the decorative film is applied.

The second acrylic pressure sensitive adhesive layer may further contain a second colorant besides the white colorant. Examples of the second colorant include pigments and dyes. A pigment or dye can each be used alone, or two or more of them can each be used in combination. The form of the pigment and dye is not particularly limited and may have undergone dispersion treatment.

Examples of the pigment and dye include, among the pigments and dyes described for the first acrylic pressure sensitive adhesive layer, inorganic pigments and organic pigments excluding white pigments, and dyes.

In a case where the second colorant is used, the second colorant is preferably a colorant exhibiting an achromatic color, that is, a black colorant. By using a black colorant as the second colorant, the lightness and chroma of the decorative film can be adjusted without changing the hue of the first acrylic pressure sensitive adhesive layer.

When the second colorant is used, the content of the second colorant can be approximately 0.1 mass % or greater, approximately 0.5 mass % or greater, or approximately 1 mass % or greater, and approximately 45 mass % or less, approximately 40 mass % or less, or approximately 35 mass % or less, based on the mass of the second acrylic pressure sensitive adhesive layer.

When the second colorant is used, the total content of the white colorant and the second colorant can be approximately 5 mass % or greater, approximately 10 mass % or greater, or approximately 15 mass % or greater, and approximately 50 mass % or less, approximately 45 mass % or less, or approximately 40 mass % or less, based on the mass of the second acrylic pressure sensitive adhesive layer.

In an embodiment, the glass transition temperature (Tg) of the adhesive polymer of the second acrylic pressure sensitive adhesive layer is approximately-40° C. or lower. By setting the glass transition temperature of the adhesive polymer to approximately −40° C. or lower, initial adhesion (tackiness) can be effectively imparted to the second acrylic pressure sensitive adhesive layer.

In an embodiment, the second acrylic pressure sensitive adhesive layer contains a carboxy group-containing (meth)acrylic polymer and an amino group-containing (meth)acrylic polymer. The carboxy group-containing (meth)acrylic polymer and the amino group-containing (meth)acrylic polymer have capability of stably dispersing a large amount of white colorant in the second acrylic pressure sensitive adhesive layer. Thus, even when the second acrylic pressure sensitive adhesive layer is made relatively thin, high concealing property can be imparted to the second acrylic pressure sensitive adhesive layer. Capability of making the second acrylic pressure sensitive adhesive layer thin is advantageous from the perspective of nonflammability of the decorative film. Furthermore, the carboxy group-containing (meth)acrylic polymer and the amino group-containing (meth)acrylic polymer interact with each other and can suppress reduction in cohesive force of the second acrylic pressure sensitive adhesive layer due to dispersion of the white colorant and can maintain the adhesive properties. The carboxy group-containing (meth)acrylic polymer and/or the amino group-containing (meth)acrylic polymer may be crosslinked with the above-described crosslinking agent.

Representative and preferred composition and production method of the carboxy group-containing (meth)acrylic polymer and the amino group-containing (meth)acrylic polymer are as described for the first acrylic pressure sensitive adhesive layer.

In the second acrylic pressure sensitive adhesive layer, at least one of the carboxy group-containing (meth)acrylic polymer or the amino group-containing (meth)acrylic polymer functions as an acrylic adhesive polymer. The acrylic adhesive polymer imparts pressure sensitive adhesiveness to the second acrylic pressure sensitive adhesive layer at the operating temperature (e.g., 5° C. to 35° C.).

The glass transition temperature (Tg) of the acrylic adhesive polymer may be approximately −70° C. to approximately −40° C. In an embodiment, the glass transition temperature of the acrylic adhesive polymer is approximately −65° C. or higher, or approximately −60° C. or higher, and approximately −45° C. or lower, or approximately −50° C. or lower. By setting the glass transition temperature of the acrylic adhesive polymer to approximately −70° C. or higher, adhesive strength and retention strength can be imparted to the second acrylic pressure sensitive adhesive layer. By setting the glass transition temperature of the acrylic adhesive polymer to approximately −40° C. or lower, initial adhesion (tackiness) can be effectively imparted to the second acrylic pressure sensitive adhesive layer. The glass transition temperature (Tg) of the acrylic adhesive polymer can be determined as a calculated glass transition temperature by using the Fox equation described above.

Representative and preferred embodiments for the weight average molecular weight (Mw) of the acrylic adhesive polymer, the mass ratio of the carboxy group-containing (meth)acrylic polymer to the amino group-containing (meth)acrylic polymer, the acrylic polymer additive, the glass transition temperature (Tg) and weight average molecular weight (Mw) thereof are the same as those described for the first acrylic pressure sensitive adhesive layer.

At least one of the carboxy group-containing (meth)acrylic polymer or the amino group-containing (meth)acrylic polymer may function as a dispersant for the white colorant and the optional second colorant. Representative and preferred dispersant and premix in this embodiment are the same as those described for the first acrylic pressure sensitive adhesive layer.

The second acrylic pressure sensitive adhesive layer can be formed on the first acrylic pressure sensitive adhesive layer or the liner by using the second colored adhesive composition containing the carboxy group-containing (meth)acrylic polymer, the amino group-containing (meth)acrylic polymer, and the white colorant, and, as necessary, a second colorant, a crosslinking agent, a solvent, and/or other additives.

Prior to preparing the second colored adhesive composition, the white colorant and the optional second colorant as well as the carboxy group-containing (meth)acrylic polymer or amino group-containing (meth)acrylic polymer that functions as a dispersant may be mixed to prepare a premix. The preparation of the premix and the second colored adhesive composition can be performed by a procedure similar to that described for the first acrylic pressure sensitive adhesive layer except for replacing “colorant” with “white colorant and optional second colorant”.

Representative and preferred crosslinking agent, solvent, and other additives are the same as those described for the first acrylic pressure sensitive adhesive layer.

The thickness of the second acrylic pressure sensitive adhesive layer may be varied based on the concealing property and adhesive properties desired for the decorative film and, for example, can be approximately 5 μm or greater, approximately 10 μm or greater, or approximately 15 μm or greater, and approximately 100 μm or less, approximately 80 μm or less, or approximately 50 μm or less. From the perspective of nonflammability of the decorative film, the thickness of the second acrylic pressure sensitive adhesive layer is preferably approximately 80 μm or less, and more preferably approximately 50 μm or less.

The decorative film can be produced according to, for example, a first method including the following process. A first acrylic pressure sensitive adhesive layer is formed by applying a first colored adhesive composition on a liner by using a knife coater or a bar coater and drying. To make the reaction of the crosslinking agent, which is an optional component, to proceed, the first acrylic pressure sensitive adhesive layer may be heated by hot air or an oven during the drying. On the obtained first acrylic pressure sensitive adhesive layer, a transparent film layer is layered by a method such as dry lamination, and thus a decorative film precursor is produced. A second acrylic pressure sensitive adhesive layer is formed by applying a second colored adhesive composition on a liner by using a knife coater or a bar coater and drying. To make the reaction of the crosslinking agent, which is an optional component, to proceed, the second acrylic pressure sensitive adhesive layer may be heated by hot air or an oven during the drying. The liner is removed from the decorative film precursor, and the first acrylic pressure sensitive adhesive layer and the second acrylic pressure sensitive adhesive layer are layered in a manner that they are in contact by a method such as dry lamination, and thus a decorative film is produced. Both of the first acrylic pressure sensitive adhesive layer and the second acrylic pressure sensitive adhesive layer have pressure sensitive adhesiveness, and thus the decorative film can be produced by the procedure described above. In this embodiment, since the liner contained in the decorative film precursor can function as a support for the transparent film layer, even when the transparent film layer is thin, handling is possible.

A decorative film can be also produced by a second method including the following process. A first acrylic pressure sensitive adhesive layer is formed by applying a first colored adhesive composition directly on a transparent film layer by using a knife coater or a bar coater and optionally drying by heating. A second acrylic pressure sensitive adhesive layer is formed by applying a second colored adhesive composition on a liner by using a knife coater or a bar coater and optionally drying by heating. The first acrylic pressure sensitive adhesive layer and the second acrylic pressure sensitive adhesive layer are layered in a manner that they are in contact by a method such as dry lamination, and thus a decorative film is produced.

A decorative film can be also produced by a third method including the following process. A first acrylic pressure sensitive adhesive layer is formed by applying a first colored adhesive composition directly on a transparent film layer by using a knife coater or a bar coater and optionally drying by heating. A second acrylic pressure sensitive adhesive layer is formed by applying a second colored adhesive composition directly on the first acrylic pressure sensitive adhesive layer by using a knife coater or a bar coater and optionally drying by heating. A liner is layered on the second acrylic pressure sensitive adhesive layer as necessary, and thus a decorative film is formed.

A decorative film can be also produced by a fourth method including the following process. A second acrylic pressure sensitive adhesive layer is formed by applying a second colored adhesive composition on a liner by using a knife coater or a bar coater and optionally drying by heating. A first acrylic pressure sensitive adhesive layer is formed by applying a first colored adhesive composition directly on the second acrylic pressure sensitive adhesive layer by using a knife coater or a bar coater and optionally drying by heating. On the first acrylic pressure sensitive adhesive layer, a transparent film layer is layered by a method such as dry lamination, and thus a decorative film is formed.

The decorative film may include a liner on the surface of the second acrylic pressure sensitive adhesive layer. Examples of the liner, which is an optional component, include plastic materials such as polyethylenes, polypropylenes, polyesters, and cellulose acetates, papers, and laminated papers of the plastic materials. These liners may have a surface that has been subjected to release-liner treatment with silicone or the like. The thickness of the liner can be typically approximately 10 μm or greater, or approximately 25 μm or greater, and approximately 500 μm or less, or approximately 200 μm or less.

The adhesive surface of the second acrylic pressure sensitive adhesive layer may be flat or may have recesses and protrusions. The adhesive surface with recesses and protrusions include an adhesive surface of the second acrylic pressure sensitive adhesive layer, in which the protrusions containing a solid content of the second colored adhesive composition or a solid content of the reaction product and the recesses surrounding the protrusions are formed, and when the adhesive surface is attached to an adherend, a communicating passage is formed between the adherend surface and the adhesive surface, the communicating passage being defined by the recesses and being in communication with the external space. An example of the method for forming the adhesive surface with recesses and protrusions will be described below.

A liner with a release surface including a prescribed recess-and-protrusion structure is prepared. The second colored adhesive composition is applied to the release surface of the liner and, as necessary, heated, and thus a second acrylic pressure sensitive adhesive layer is formed. Thus, the recess-and-protrusion structure (negative structure) of the liner is transferred to the surface of the second acrylic pressure sensitive adhesive layer, the surface being in contact with the liner (to serve as the adhesive surface in the decorative film), and thus an adhesive surface with recesses and protrusions including the predetermined structure (positive structure) at the adhesive surface is formed. As described above, the recesses and protrusions of the adhesive surface are designed in advance to include a groove that allows formation of the communicating passage when the protrusions adhere to the adherend. The second acrylic pressure sensitive adhesive layer formed on the liner can be used in the first method, the second method, and the fourth method described above.

For the groove of the second acrylic pressure sensitive adhesive layer, the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably approximately 10 μm or greater, or approximately 100 μm or greater, and approximately 2000 μm or less, or approximately 1000 μm or less. The depth of the grooves (distance from the adhesion face to the bottom of the groove measured toward the direction of the transparent film layer) is typically approximately 10 μm or greater and approximately 100 μm or less. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

In a partial laminate that is a component of the decorative film and that includes the transparent film layer and the first acrylic pressure sensitive adhesive layer but does not include the second acrylic pressure sensitive adhesive layer, when a color difference ΔE* is measured from a side of the transparent film layer with the background color being white and black, a color difference ΔE* is approximately 13 or greater between a part of the white background color and a part of the black background color. The color difference ΔE* may be approximately 15 or greater, or approximately 20 or greater. The partial laminate of the present disclosure is defined as a laminate including all the layers constituting the decorative film, such as a primer layer and a surface-protecting layer that are optionally arranged on the transparent film layer in addition to the transparent film layer and the first acrylic pressure sensitive adhesive layer, but excluding the second acrylic pressure sensitive adhesive layer and the liner. The partial laminate of the present disclosure can be obtained by removing the second acrylic pressure sensitive adhesive layer from the decorative film. The color difference ΔE being approximately 13 or greater means that the first acrylic pressure sensitive adhesive layer is a layer which mainly contributes to the hue, lightness, and chroma of the decorative film and which hardly contributes to the concealing property of the decorative film. The color difference ΔE* is determined according to the procedure described in the section of “3. Concealing power” of Examples by using a spectrophotometer.

In the decorative film, when a color difference ΔE* is measured from a side of the transparent film layer with the background color being white and black, the color difference ΔE* is approximately 11 or less between a part of the white background color and a part of the black background color. In the context of the color difference ΔE*, a liner is not included in the decorative film. The color difference ΔE* is preferably approximately 8 or less, and more preferably approximately 6 or less. Taking the color difference ΔE* of the partial laminate being approximately 13 or greater into consideration, the color difference ΔE* being approximately 11 or less means that the second acrylic pressure sensitive adhesive layer is a layer that mainly contributes to the concealing property of the decorative film. The color difference ΔE* is determined according to the procedure described in the section of “3. Concealing power” of Examples by using a spectrophotometer.

In an embodiment, when the decorative film is attached to an aluminum sheet and the chroma C* is measured from the side of the transparent film layer, the chroma C* is approximately 40 or greater. The chroma C* may be approximately 50 or greater, approximately 65 or greater, or approximately 80 or greater. The chroma C being approximately 40 or greater means that the visually recognized color of the decorative film having high chroma. The chroma C* is determined according to the procedure described in the section of “4. Chroma C*” of Examples by using a spectrophotometer.

Various thicknesses can be employed for the decorative film; however, from the perspective of flame retardance, the thickness of the decorative film is preferably approximately 240 μm or less. The decorative film having a thickness of approximately 240 μm or less can impart required flame retardance to the decorative film. In the present disclosure, the thickness of the decorative film does not include the thickness of the liner. The thickness of the decorative film can be approximately 200 μm or less or approximately 100 μm or less. The thickness of the decorative film can be approximately 30 μm or greater, approximately 40 μm or greater, or approximately 50 μm or greater.

The decorative film has a total heat release of 8 MJ/m² or less for 20 minutes after start of heating as measured in accordance with ISO 5660-1 cone calorimeter heat release test. In an embodiment, the total heat release is approximately 7 MJ/m² or less, or approximately 6 MJ/m² or less. The decorative film having a total heat release of 8 MJ/m² or less is evaluated as being nonflammable.

In an embodiment, the decorative film is essentially free of flame retardants. Note that “essentially free” means that the flame retardant is contained in approximately less than 1 mass %, approximately less than 0.5 mass %, or approximately less than 0.2 mass % relative to the mass of the decorative film. Examples of the flame retardant include organic flame retardants such as bromine-based flame retardants, phosphorus-based flame retardants, and chlorine-based flame retardants, and inorganic flame retardants such as antimony compounds, metal hydroxides, nitrogen compounds, and boron compounds. In the present disclosure, pigments that can function as a flame retardant, such as titanium oxide, is not included in the content of the flame retardant.

The decorative film of the present disclosure can be suitably used for interior and exterior uses such as uses for vehicles including automobiles, trains, and ships, and for buildings; and for exterior uses such as uses for exterior walls of storage tanks and transformer facilities. In an embodiment, the decorative film is for vehicles.

### EXAMPLES

In the following examples, specific embodiments of the present disclosure will be exemplified, but the present invention is not limited to those embodiments. All ‘part’ and ‘percent’ are based on mass unless otherwise specified.

The raw materials used in the production of the decorative film are shown in Table 1.

TABLE 1

| | Composition or description¹⁾ | Supplier |
|---|---|---|
| Transparent | PF900, acrylic film, thickness: | 3M Japan Ltd. |
| film 1 (FL1) | 53 μm | (Shinagawa-ku, Tokyo, |
| | | Japan) |
| Transparent | Denka DX Film DX-14S02, | Denka Company Limited |
| film 2 (FL2) | PMMA/PVdF film, transparent | (Chuo-ku, Tokyo, Japan) |
| | grade, thickness: 30 μm | |
| Transparent | Thermoplastic polyester | Sheedom Co., Ltd. |
| film 3 (FL3) | polyurethane elastomer film, | (Osaka-shi, Osaka, |
| | thickness 150 μm, non-yellowing | Japan) |
| Transparent | TOYOBO ESTER (trademark) | Toyobo Film Solutions |
| film 4 (FL4) | Film HB3, biaxially-oriented | Ltd. |
| | PET film, thickness: 50 μm | (Chuo-ku, Tokyo, Japan) |
| Transparent | JS1900XL, PVC film, thickness: | 3M Japan Ltd. |
| film 5 (FL5) | 53 μm | (Shinagawa-ku, Tokyo, |
| | | Japan) |
| (Meth)acrylic | MMA-BMA-DMAEMA = | — |
| polymer 1 | 60:34:6, Tg = 63° C., weight | |
| (AP1) | average molecular weight (Mw): | |
| | 68000, 40 mass % EtOAc solution | |
| (Meth)acrylic | BA-2EHA-Vac-AA-ACM = | — |
| polymer 2 | 40:47:8:5:0.1, Tg = −51° C., | |
| (AP2) | weight average molecular weight | |
| | (Mw): 550000, 40 mass % | |
| | toluene/EtOAc solution | |
| Tacky | BA-2EHA-AN-AA = 58:36:2:4, | — |
| adhesive | Tg = −53° C., weight average | |
| polymer 1 | molecular weight (Mw): 500000, | |
| (ADH1) | 33 mass % EtOAc solution | |
| Tacky | 2EHA-BA-AA = 64:30:6, | — |
| adhesive | Tg = −57° C., weight average | |
| polymer 2 | molecular weight (Mw): 280000, | |
| (ADH2) | 60 mass % EtOAc solution | |
| Tacky | BA-AA = 96:4, Tg = −50° C., | — |
| adhesive | weight average molecular weight | |
| polymer 3 | (Mw): 580000, 42 mass % | |
| (ADH3) | toluene/EtOAc solution | |
| Tacky | 2EHA-BA-AA = 64:30:6, | — |
| adhesive | Tg = −57° C., weight average | |
| polymer 4 | molecular weight (Mw): 250000, | |
| (ADH4) | 60 mass % EtOAc solution | |
| Crosslinking | Bisamide-based crosslinking | 3M Japan Ltd. |
| agent 1 (CL1) | agent, 1,1′-isophthaloyl-bis(2- | (Shinagawa-ku, Tokyo, |
| | methylaziridine), 5 mass % | Japan) |
| | toluene solution | |
| Crosslinking | Tetrad-X, polyfunctional liquid | Mitsubishi Gas Chemical |
| agent 2 (CL2) | epoxy resin, N,N,N′, N′- | Company, Inc. |
| | tetraglycidyl-m-xylenediamine | (Chiyoda-ku, Tokyo, |
| | | Japan) |
| Pigment 1 | PW6, TiPure (trademark) R960, | The Chemours Company |
| (PG1) | titanium dioxide (TiO₂) | (Wilmington, Delaware, |
| | | US) |
| Pigment 2 | PR122, FASTOGEN (trademark) | DIC Corporation |
| (PG2) | SUPER MAGENTA R | (Chuo-ku, Tokyo, Japan) |
| Pigment 3 | PY154, Hostaperm (trademark) | Clariant International |
| (PG3) | Yellow H3G | AG |
| | | (Muttenz, Basel- |
| | | Landschaft, Switzerland) |
| Pigment 4 | PV19, Cinquasia (trademark) Red | BASF |
| (PG4) | K 4104 | (Ludwigshafen am |
| | | Rhein, Rhineland- |
| | | Palatinate, Germany) |
| Pigment 5 | PG7, Phthalocyanine Green | Dainichiseika Color & |
| (PG5) | 2GNL | Chemicals Mfg. Co., |
| | | Ltd. |
| | | (Chuo-ku, Tokyo, Japan) |
| Pigment 6 | PB15:4, Chromofine blue 4982 | Dainichiseika Color & |
| (PG6) | | Chemicals Mfg. Co., |
| | | Ltd. |
| | | (Chuo-ku, Tokyo, Japan) |
| Release liner 1 | KPM11S | Lintec Corporation |
| (L1) | | (Itabashi-ku, Tokyo, |
| | | Japan) |
| Release liner 2 | SCW860DNL, surface-structured | 3M Japan Ltd. |
| (L2) | liner | (Shinagawa-ku, Tokyo, |
| | | Japan) |

¹⁾MMA: methyl methacrylate, BMA: n-butyl methacrylate, DMAEMA, 2-(dimethylamino)ethyl methacrylate, BA: n-butyl acrylate, 2EHA: 2-ethylhexyl acrylate, Vac: vinyl acetate, AA: acrylic acid, ACM: acrylamide, AN: acrylonitrile, EtOAc: ethyl acetate

The compositions of Millbases 1 to 3 (premixes) used in production of decorative films are shown in Table 2.

TABLE 2

| | | | Resin | | |
|---|---|---|---|---|---|
| | Pigment | | | mass % | |
| | Type | mass % | Type | (solid content) | Solvent¹⁾ |
| Millbase 1 (MB1) | PG1 | 55 | AP1 | 11 | MEK |
| Millbase 2 (MB2) | PG2 | 10 | AP2 | 16 | MIBK |
| Millbase 3 (MB3) | PG3 | 10 | AP2 | 16 | MIBK |
| Millbase 4 (MB4) | PG4 | 10 | AP2 | 16 | MIBK |
| Millbase 5 (MB5) | PG5 | 10 | AP2 | 16 | MIBK |
| Millbase 6 (MB6) | PG6 | 10 | AP2 | 16 | MIBK |

¹⁾MEK: methyl ethyl ketone, MIBK: methyl isobutyl ketone

The compositions of colored adhesive compositions CA1 to CA13 used in production of decorative films are shown in Table 3. The colored adhesive compositions CA1 to CA13 were prepared by mixing millbases 1 to 6 and materials.

TABLE 3
(numerical values are in dry mass %)

| | CA1 | CA2 | CA3 | CA4 | CA5 | CA6 | CA7 | CA8 | CA9 | CA10 | CA11 | CA12 | CA13 |
|---|---|---|---|---|---|---|---|---|---|---|---|---|---|
| Color | Magenta | White | Yellow | White | White | Yellow | White | White | White | Red | Magenta | Green | Blue |
| PG1 | 2 | 40 | — | 40 | 40 | — | 40 | 40 | 40 | — | — | — | — |
| PG2 | 3 | — | — | — | — | — | — | — | — | — | 4 | — | — |
| PG3 | — | — | 40 | — | — | 20 | — | — | — | — | — | — | — |
| PG4 | — | — | — | — | — | — | — | — | — | 4 | — | — | — |
| PG5 | — | — | — | — | — | — | — | — | — | — | — | 4 | — |
| PG6 | — | — | — | — | — | — | — | — | — | — | — | — | 2 |
| ADH1 | 95 | 100 | — | — | — | — | — | — | — | — | — | — | — |
| ADH2 | — | — | 36 | — | 100 | 68 | 100 | 100 | — | 94 | 94 | — | 97 |
| ADH3 | — | — | — | 100 | — | — | — | — | — | — | — | — | — |
| ADH4 | — | — | — | — | — | — | — | — | 100 | — | — | — | — |
| AP1 | 5 | 8 | 5 | 8 | 8 | 5 | 8 | 8 | 8 | 5 | 5 | 5 | 5 |
| AP2 | 5 | — | 64 | — | — | 32 | — | — | — | 6 | 6 | 6 | 3 |
| CL1 | 0.1 | 0.2 | — | — | — | — | — | — | — | — | — | — | — |
| CL2 | — | — | 0.18 | 0.05 | 0.05 | 0.18 | 0.23 | 0.12 | 0.23 | 0.18 | 0.18 | 0.18 | 0.18 |
| Solid | 28 | 30 | 31 | 38 | 58 | 31 | 58 | 58 | 58 | 44 | 44 | 44 | 44 |
| content | | | | | | | | | | | | | |
| (mass %) | | | | | | | | | | | | | |

### Example 1

The colored adhesive composition CA1 was applied on a liner 1 (L1) by using a knife coater and dried at 95° C. for 5 minutes. After the drying, a first acrylic pressure sensitive adhesive layer having a thickness of 30 μm was obtained. The first acrylic pressure sensitive adhesive layer was adhered to the film 1 (FL1), and thus a decorative film precursor was obtained. The colored adhesive composition CA2 was then applied on an L1 by using a knife coater and dried at 95° C. for 5 minutes. After the drying, a second acrylic pressure sensitive adhesive layer having a thickness of 30 μm was obtained. The L1 of the decorative film precursor was peeled off, the second acrylic pressure sensitive adhesive layer was layered on the first acrylic pressure sensitive adhesive layer, and thus a decorative film of Example 1 was obtained.

### Example 2

The colored adhesive composition CA3 was applied on an L1 by using a knife coater and dried at 95° C. for 5 minutes. After the drying, a first acrylic pressure sensitive adhesive layer having a thickness of 22 μm was obtained. The first acrylic pressure sensitive adhesive layer was adhered to the film 2 (FL2), and thus a decorative film precursor was obtained. The colored adhesive composition CA4 was then applied on an L1 by using a knife coater and dried at 95° C. for 5 minutes. After the drying, a second acrylic pressure sensitive adhesive layer having a thickness of 40 μm was obtained. The L1 of the decorative film precursor was peeled off, the second acrylic pressure sensitive adhesive layer was layered on the first acrylic pressure sensitive adhesive layer, and thus a decorative film of Example 2 was obtained.

### Example 3

A decorative film of Example 3 was obtained by the same procedure as for Example 2 except for changing the colored adhesive composition from CA4 to CA5, and changing the thickness of the second acrylic pressure sensitive adhesive layer to 23 μm.

### Example 4

A decorative film of Example 4 was obtained by the same procedure as for Example 3 except for changing the thickness of the second acrylic pressure sensitive adhesive layer to 15 μm.

### Example 5

A decorative film of Example 5 was obtained by the same procedure as for Example 3 except for changing the thickness of the second acrylic pressure sensitive adhesive layer to 34 μm.

### Example 6

The colored adhesive composition CA6 was applied on an L1 by using a knife coater and dried at 95° C. for 5 minutes. After the drying, a first acrylic pressure sensitive adhesive layer having a thickness of 20 μm was obtained. The first acrylic pressure sensitive adhesive layer was adhered to the FL2, and thus a decorative film precursor was obtained. The colored adhesive composition CA7 was then applied on an liner 2 (L2) by using a knife coater and dried at 95° C. for 5 minutes. After the drying, a second acrylic pressure sensitive adhesive layer having a thickness of 34 μm was obtained. The L1 of the decorative film precursor was peeled off, the second acrylic pressure sensitive adhesive layer was layered on the first acrylic pressure sensitive adhesive layer, and thus a decorative film of Example 6 was obtained.

### Example 7

A decorative film of Example 7 was obtained by the same procedure as for Example 6 except for changing the colored adhesive composition from CA7 to CA8 containing a different crosslinking agent content, and changing the thickness of the second acrylic pressure sensitive adhesive layer to 33 μm.

### Example 8

The colored adhesive composition CA6 was applied on an L1 by using a knife coater and dried at 95° C. for 5 minutes. After the drying, a first acrylic pressure sensitive adhesive layer having a thickness of 20 μm was obtained. The first acrylic pressure sensitive adhesive layer was adhered to the FL2, and thus a decorative film precursor was obtained. The colored adhesive composition CA9 was then applied on an L1 by using a knife coater and dried at 95° C. for 5 minutes. After the drying, a second acrylic pressure sensitive adhesive layer having a thickness of 30 μm was obtained. The L1 of the decorative film precursor was peeled off, the second acrylic pressure sensitive adhesive layer was layered on the first acrylic pressure sensitive adhesive layer, and thus a decorative film of Example 8 was obtained.

### Example 9

A decorative film of Example 9 was obtained by the same procedure as for Example 8 except for changing the thickness of the first acrylic pressure sensitive adhesive layer to 40 μm.

### Example 10

The colored adhesive composition CA6 was applied on a film 3 (FL3) by using a knife coater and dried at 95° C. for 5 minutes. After the drying, a first acrylic pressure sensitive adhesive layer having a thickness of 21 μm was obtained. The colored adhesive composition CA8 was then applied on the first acrylic pressure sensitive adhesive layer by using a knife coater and dried at 95° C. for 5 minutes. After the drying, a second acrylic pressure sensitive adhesive layer having a thickness of 36 μm was obtained. The L1 was layered on the second acrylic pressure sensitive adhesive layer, a support film (attached to FL3 at the time of acquisition) of FL3 was removed, and thus a decorative film of Example 10 was obtained.

### Example 11

A decorative film of Example 11 was obtained by the same procedure as for Example 10 except for changing the FL3 to a film 4 (FL4), changing the thickness of the first acrylic pressure sensitive adhesive layer to 16 μm, and changing the thickness of the second acrylic pressure sensitive adhesive layer to 38 μm.

### Example 12

The colored adhesive composition CA9 was applied on an L1 by using a knife coater and dried at 95° C. for 5 minutes. After the drying, a second acrylic pressure sensitive adhesive layer having a thickness of 29 μm was obtained. The colored adhesive composition CA6 was then applied on the second acrylic pressure sensitive adhesive layer by using a knife coater and dried at 95° C. for 5 minutes. After the drying, a first acrylic pressure sensitive adhesive layer having a thickness of 20 μm was obtained. The FL2 was layered on the first acrylic pressure sensitive adhesive layer, and thus a decorative film of Example 12 was obtained.

### Example 13

A decorative film of Example 13 was obtained by the same procedure as for Example 12 except for changing the transparent film layer from FL2 to FL5.

### Example 14 to Example 21

Decorative films of Example 14 to Example 21 were each obtained by the same procedure as for Example 8 except for changing the first acrylic pressure sensitive adhesive layer as described in Table 4.

### Comparative Example 1

A decorative film of Comparative Example 1 was obtained by the same procedure as for Example 1 except for using no second acrylic pressure sensitive adhesive layer.

### Comparative Example 2

A decorative film of Comparative Example 2 was obtained by the same procedure as for Example 2 except for using no second acrylic pressure sensitive adhesive layer.

### Comparative Example 3

A decorative film of Comparative Example 3 was obtained by the same procedure as for Example 5 except for using no first acrylic pressure sensitive adhesive layer.

### Comparative Example 4 to Comparative Example 11

Decorative films of Comparative Example 4 to Comparative Example 11 were respectively obtained by the same procedure as for Example 14 to Example 21 except for using no second acrylic pressure sensitive adhesive layer.

The decorative film was evaluated for the following.

### 1. Adhesive Force

A test piece was prepared by cutting a decorative film into a width of 25 mm and a length of 150 mm. The test piece was adhered on a melamine-coated plate (Paltek Corporation, Hiratsuka-shi, Kanagawa, Japan) at 20° C. The adhering method was in accordance with JIS Z 0237:2009 8.2.3. The test piece was left at 20° C. for 48 hours. Using a tensile tester (Tensilon (registered trademark) universal testing machine, model: RTC-1210A, A&D Company, Limited, Toshima-ku, Tokyo, Japan), the adhesive strength (N/25 mm) at the time of performing 180 degree peeling was measured at a peeling rate of 300 mm/min at a temperature of 20° C.

### 2. Heat Shrinkage

A test piece was prepared by cutting a decorative film into a width of 50 mm and a length of 100 mm. The test piece was adhered on an aluminum sheet A5052P (Paltek Corporation (Hiratsuka-shi, Kanagawa, Japan)) in an environment at 23° C. by a roller and left for 24 hours in an environment at 23° C. On the test piece, cut in shape of cross was made by a utility knife. The test piece was then heated at 65° C. for 48 hours. After the heat aging, the shrinkage (mm) of the film was measured by a microscope, and a maximum value was recorded.

### 3. Concealing Power

A test piece was produced by cutting a decorative film into a square with 50 mm side. The test piece was adhered on a concealing power chart (checks, concealing power chart, SEIEIDO Printing Co., Ltd. (Yonezawa-shi, Yamagata, Japan)). For the white region and black region, the L″, a*, and b* values of the test piece were measured by using a spectrophotometer (CM-3700d, Konica Minolta Japan, Inc. (Minato-ku, Tokyo, Japan)). Taking the measured value of the white region as L₁*, a₁*, b₁* and taking the measured value of the black region as L₂*, a₂*, b₂*, the color difference ΔE* as an indicator of the concealing power was calculated by the following equation:

ΔE*=[(L₂*−L₁*)²+(a₂*−a₁*)²+(b₂*−b₁*)²]^{1/2}.

A case where the color difference ΔE* was less than 6 was evaluated as “A”, a case where the color difference ΔE″ was 6 or greater and less than 12 was evaluated as “B”, and a case where the color difference ΔE* was 12 or greater was evaluated as “C”. “A” is evaluated as having excellent concealing property, and “B” is evaluated as having good concealing property.

### 4. Chroma C*

The test piece produced for the concealing power test was adhered on an aluminum plate (Paltek Corporation (Hiratsuka-shi, Kanagawa, Japan)), and the L*, a*, and b* values of the test piece were measured by using a spectrophotometer (CM-3700d, Konica Minolta Japan, Inc. (Minato-ku, Tokyo, Japan)). Chroma C* was determined by calculation based on the following equation:

C*=[(a*)²+(b*)²]^{1/2}.

### 5. Nonflammability Test

A decorative film was adhered on a zinc-plated steel plate (thickness: 0.27 mm). Test was conducted in accordance with ISO 5660-1 cone calorimeter heat release test. A heat release rate (kW/m²) and a total heat release (MJ/m²) were measured as parameters using a cone calorimeter (available from Toyo Seiki Seisaku-sho, Ltd.). When the total heat release for 20 minutes after start of heating was 8 MJ/m² or lower and the time indicating a heat release rate exceeding 200 kW/m² was 10 seconds or shorter in total, the decorative film was determined to pass, and otherwise the decorative film was determined to fail.

The constitutions and evaluation results of decorative films of Example 1 to Example 21 and Comparative Example 1 to Comparative Example 11 are shown in Table 4 and Table 5.

TABLE 4

| | | | First acrylic pressure sensitive | | | | Second acrylic pressure sensitive | | | | |
|---|---|---|---|---|---|---|---|---|---|---|---|
| | | | adhesive layer | | | | adhesive layer | | | | |
| | | | | Crosslinking | | | | Crosslinking | | | |
| | | | | agent | | | | agent | | | |
| | Transparent | Product | | | Part by | Thickness | | | Part by | Thickness | |
| | film layer | color | Composition | Type | mass | [μm] | Composition | Type | mass | [μm] | liner |
| Example 1 | FL1 | Magenta | CA1 | CL1 | 0.05 | 30 | CA2 | CL1 | 0.05 | 30 | L1 |
| Example 2 | FL2 | Yellow | CA3 | CL2 | 0.18 | 22 | CA4 | CL2 | 0.05 | 40 | L1 |
| Example 3 | FL2 | Yellow | CA3 | CL2 | 0.18 | 22 | CA5 | CL2 | 0.05 | 23 | L1 |
| Example 4 | FL2 | Yellow | CA3 | CL2 | 0.18 | 22 | CA5 | CL2 | 0.05 | 15 | L1 |
| Example 5 | FL2 | Yellow | CA3 | CL2 | 0.18 | 22 | CA5 | CL2 | 0.05 | 34 | L1 |
| Example 6 | FL2 | Yellow | CA6 | CL2 | 0.18 | 20 | CA7 | CL2 | 0.23 | 34 | L2 |
| Example 7 | FL2 | Yellow | CA6 | CL2 | 0.18 | 20 | CA8 | CL2 | 0.12 | 33 | L2 |
| Example 8 | FL2 | Yellow | CA6 | CL2 | 0.18 | 20 | CA9 | CL2 | 0.23 | 30 | L1 |
| Example 9 | FL2 | Yellow | CA6 | CL2 | 0.18 | 40 | CA9 | CL2 | 0.23 | 30 | L1 |
| Example 10 | FL3 | Yellow | CA6 | CL2 | 0.18 | 21 | CA8 | CL2 | 0.12 | 36 | L1 |
| Example 11 | FL4 | Yellow | CA6 | CL2 | 0.18 | 16 | CA8 | CL2 | 0.12 | 38 | L1 |
| Example 12 | FL2 | Yellow | CA6 | CL2 | 0.18 | 20 | CA9 | CL2 | 0.23 | 29 | L1 |
| Example 13 | FL5 | Yellow | CA6 | CL2 | 0.18 | 20 | CA9 | CL2 | 0.23 | 29 | L1 |
| Comparative | FL1 | Magenta | CA1 | CL1 | 0.05 | 30 | No | | | | L1 |
| Example 1 | | | | | | | | | | | |
| Comparative | FL2 | Yellow | CA3 | CL2 | 0.18 | 22 | No | | | | L1 |
| Example 2 | | | | | | | | | | | |
| Comparative | FL2 | White | No | | | | CA5 | CL2 | 0.05 | 34 | L1 |
| Example 3 | | | | | | | | | | | |
| Comparative | FL2 | Red | CA10 | CL2 | 0.18 | 22 | No | | | | L1 |
| Example 4 | | | | | | | | | | | |
| Comparative | FL2 | Magenta | CA11 | CL2 | 0.18 | 22 | No | | | | L1 |
| Example 5 | | | | | | | | | | | |
| Comparative | FL2 | Red | CA10 | CL2 | 0.18 | 33 | No | | | | L1 |
| Example 6 | | | | | | | | | | | |
| Comparative | FL2 | Magenta | CA11 | CL2 | 0.18 | 35 | No | | | | L1 |
| Example 7 | | | | | | | | | | | |
| Example 14 | FL2 | Red | CA10 | CL2 | 0.18 | 22 | CA9 | CL2 | 0.23 | 30 | L1 |
| Example 15 | FL2 | Magenta | CA11 | CL2 | 0.18 | 22 | CA9 | CL2 | 0.23 | 30 | L1 |
| Example 16 | FL2 | Red | CA10 | CL2 | 0.18 | 33 | CA9 | CL2 | 0.23 | 30 | L1 |
| Example 17 | FL2 | Magenta | CA11 | CL2 | 0.18 | 35 | CA9 | CL2 | 0.23 | 30 | L1 |
| Comparative | FL2 | Green | CA12 | CL2 | 0.18 | 24 | No | | | | L1 |
| Example 8 | | | | | | | | | | | |
| Comparative | FL2 | Blue | CA13 | CL2 | 0.18 | 21 | No | | | | L1 |
| Example 9 | | | | | | | | | | | |
| Comparative | FL2 | Green | CA12 | CL2 | 0.18 | 37 | No | | | | L1 |
| Example 10 | | | | | | | | | | | |
| Comparative | FL2 | Blue | CA13 | CL2 | 0.18 | 35 | No | | | | L1 |
| Example 11 | | | | | | | | | | | |
| Example 18 | FL2 | Green | CA12 | CL2 | 0.18 | 24 | CA9 | CL2 | 0.23 | 30 | L1 |
| Example 19 | FL2 | Blue | CA13 | CL2 | 0.18 | 21 | CA9 | CL2 | 0.23 | 30 | L1 |
| Example 20 | FL2 | Green | CA12 | CL2 | 0.18 | 37 | CA9 | CL2 | 0.23 | 30 | L1 |
| Example 21 | FL2 | Blue | CA13 | CL2 | 0.18 | 35 | CA9 | CL2 | 0.23 | 30 | L1 |

TABLE 5

| | Adhesive | Heat | Concealing | | | |
|---|---|---|---|---|---|---|
| | strength | shrinkage | power | | Chroma | Non- |
| | [N/25 mm] | [mm] | ΔE* | Rating | C* | flammability |
| Example 1 | 17 | 0.05 | 2.3 | A | 51 | Pass |
| Example 2 | 19 | 0.20 | 0.6 | A | 94 | Pass |
| Example 3 | 23 | 0.26 | 5.7 | A | 93 | Pass |
| Example 4 | 21 | 0.24 | 10.2 | B | 90 | Pass |
| Example 5 | 26 | 0.24 | 3.5 | A | 96 | Pass |
| Example 6 | 11 | 0.16 | 3.5 | A | 97 | Pass |
| Example 7 | 18 | 0.22 | 3.7 | A | 97 | Pass |
| Example 8 | 16 | 0.18 | 4.2 | A | 97 | Pass |
| Example 9 | ND | ND | 3.3 | A | 96 | Pass |
| Example 10 | 13 | 0.16 | 3.0 | A | 93 | Pass |
| Example 11 | 18 | 0.12 | 3.3 | A | 86 | Pass |
| Example 12 | 13 | 0.15 | 4.2 | A | 96 | Pass |
| Example 13 | 18 | 0.11 | 4.1 | A | 94 | Pass |
| Comparative | 20 | 0.05 | 13.8 | C | 46 | Pass |
| Example 1 | | | | | | |
| Comparative | 12 | 0.13 | 30.2 | C | 77 | Pass |
| Example 2 | | | | | | |
| Comparative | 20 | 0.24 | 2.6 | A | 1 | Pass |
| Example 3 | | | | | | |
| Comparative | 16 | 0.14 | 43.9 | C | 48 | Pass |
| Example 4 | | | | | | |
| Comparative | 16 | 0.14 | 39.0 | C | 45 | Pass |
| Example 5 | | | | | | |
| Comparative | 16 | 0.15 | 34.7 | C | 50 | Pass |
| Example 6 | | | | | | |
| Comparative | 18 | 0.14 | 30.6 | C | 40 | Pass |
| Example 7 | | | | | | |
| Example 14 | 18 | 0.15 | 3.1 | A | 65 | Pass |
| Example 15 | 17 | 0.18 | 2.6 | A | 55 | Pass |
| Example 16 | 17 | 0.16 | 2.7 | A | 64 | Pass |
| Example 17 | 17 | 0.18 | 2.1 | A | 51 | Pass |
| Comparative | 17 | 0.15 | 71.8 | C | 64 | Pass |
| Example 8 | | | | | | |
| Comparative | 17 | 0.15 | 44.4 | C | 41 | Pass |
| Example 9 | | | | | | |
| Comparative | 18 | 0.16 | 58.5 | C | 55 | Pass |
| Example 10 | | | | | | |
| Comparative | 18 | 0.16 | 35.4 | C | 35 | Pass |
| Example 11 | | | | | | |
| Example 18 | 18 | 0.18 | 2.3 | A | 70 | Pass |
| Example 19 | 17 | 0.16 | 2.6 | A | 47 | Pass |
| Example 20 | 18 | 0.16 | 4.4 | A | 61 | Pass |
| Example 21 | 18 | 0.15 | 0.8 | A | 42 | Pass |

Various variations of the above-mentioned embodiments and examples will be apparent to those skilled in the art without departing from the basic principle of the present invention. It is also obvious to a person skilled in the art that various improvement and modifications to the present invention can be implemented without departing from the spirit and scope of the present invention. Some of the embodiments of the present disclosure are described below.

### First Aspect

A decorative film including: a transparent film layer, a first acrylic pressure sensitive adhesive layer containing a colorant, and a second acrylic pressure sensitive adhesive layer containing a white colorant in this order,
in which, in a partial laminate which is a component of the decorative film and includes the transparent film layer and the first acrylic pressure sensitive adhesive layer but does not include the second acrylic pressure sensitive adhesive layer, when a color difference ΔE* is measured from a side of the transparent film layer with background colors being white and black, the color difference ΔE* is 13 or greater between a part of the white background color and a part of the black background color, and
in the decorative film, when a color difference ΔE* is measured from the side of the transparent film layer with background colors being white and black, the color difference ΔE* is 11 or less between a part of the white background color and a part of the black background color.

### Second Aspect

The decorative film according to the first aspect, where a chroma C* is 40 or greater when the C* is measured from the side of the transparent film layer with the decorative film attached to an aluminum sheet.

### Third Aspect

The decorative film according to the first or second aspect, where a glass transition temperature of an adhesive polymer of the first acrylic pressure sensitive adhesive layer is −40° C. or lower.

### Fourth Aspect

The decorative film according to any one of the first to third aspects, where the first acrylic pressure sensitive adhesive layer contains a carboxy group-containing (meth)acrylic polymer and an amino group-containing (meth)acrylic polymer.

### Fifth Aspect

The decorative film according to any one of the first to fourth aspects, where a glass transition temperature of an adhesive polymer of the second acrylic pressure sensitive adhesive layer is −40° C. or lower.

### Sixth Aspect

The decorative film according to any one of the first to fifth aspects, where the second acrylic pressure sensitive adhesive layer contains a carboxy group-containing (meth)acrylic polymer and an amino group-containing (meth)acrylic polymer.

### Seventh Aspect

The decorative film according to any one of the first to sixth aspects, where a thickness of the decorative film is 240 μm or less.

### Eighth Aspect

The decorative film according to any one of the first to seventh aspects, where a total heat release for 20 minutes after start of heating as measured in accordance with ISO 5660-1 Heat Release Rate (cone calorimeter method) is 8 MJ/m² or less.

### Ninth Aspect

The decorative film according to any one of the first to eighth aspects, where the decorative film contains substantially no flame retardant.

### REFERENCE SIGNS LIST

10 Decorative film
12 Transparent film layer
14 First acrylic pressure sensitive adhesive layer
16 Second acrylic pressure sensitive adhesive layer
18 Liner

1. A decorative film comprising: a transparent film layer, a first acrylic pressure sensitive adhesive layer containing a colorant, and a second acrylic pressure sensitive adhesive layer containing a white colorant in this order,
wherein, in a partial laminate which is a component of the decorative film and includes the transparent film layer and the first acrylic pressure sensitive adhesive layer but does not include the second acrylic pressure sensitive adhesive layer, when a color difference ΔE is measured from a side of the transparent film layer with background colors being white and black, the color difference ΔE* is 13 or greater between a part of the white background color and a part of the black background color, and
in the decorative film, when a color difference ΔE* is measured from the side of the transparent film layer with background colors being white and black, the color difference ΔE* is 11 or less between a part of the white background color and a part of the black background color.

2. The decorative film according to claim 1, wherein a chroma C* is 40 or greater when the chroma C* is measured from the side of the transparent film layer with the decorative film attached to an aluminum sheet.

3. The decorative film according to claim 1, wherein a glass transition temperature of an adhesive polymer of the first acrylic pressure sensitive adhesive layer is −40° C. or lower.

4. The decorative film according to claim 1, wherein the first acrylic pressure sensitive adhesive layer contains a carboxy group-containing (meth)acrylic polymer and an amino group-containing (meth)acrylic polymer.

5. The decorative film according to claim 1, wherein a glass transition temperature of an adhesive polymer of the second acrylic pressure sensitive adhesive layer is −40° C. or lower.

6. The decorative film according to claim 1, wherein the second acrylic pressure sensitive adhesive layer contains a carboxy group-containing (meth)acrylic polymer and an amino group-containing (meth)acrylic polymer.

7. The decorative film according to claim 1, wherein a thickness of the decorative film is 240 μm or less.

8. The decorative film according to claim 1, wherein a total heat release for 20 minutes after start of heating as measured in accordance with ISO 5660-1 Heat Release Rate (cone calorimeter method) is 8 MJ/m² or less.

9. The decorative film according to claim 1, wherein the decorative film contains substantially no flame retardant.
